(19) United States
(12) Patent Application Publication
(10) Pub. No.: US 2023/0391972 A1
(43) Pub. Date: Dec. 7, 2023

(54) METHOD FOR PREPARING FOAM MATERIALS BY SUPERCRITICAL FOAMING

(71) Applicant: DMN MATERIAL TECHNOLOGY (JIANGSU) LIMITED, Nanjing (CN)

(72) Inventors: Peng BAI, Nanjing (CN); Zhenxiu ZHANG, Nanjing (CN)

(21) Appl. No.: 18/234,897

(22) Filed: Aug. 17, 2023

Related U.S. Application Data
(63) Continuation of application No. PCT/CN2022/079781, filed on Mar. 8, 2022.

(51) Int. Cl. C08J 9/12; C08K 3/04

(52) U.S. Cl. CPC C08J 9/122; C08J 9/125; C08K 3/042; C08J 2203/06; C08J 2203/08; C08J 2323/28

(57) ABSTRACT

The invention relates to the field of foaming technology, in particular to CO8G101/00. A method for preparing chlorinated polyethylene materials by supercritical foaming includes the following steps: (1) Add the chlorinated polyethylene material into the reactor, add water and foaming nucleating agent, and then close the reactor cover; (2) Heat to 50-80 degrees C.; (3) Inject supercritical carbon dioxide into the reactor, so that the chlorinated polyethylene material can achieve saturation adsorption of supercritical carbon dioxide; (4) Remove and treat the chlorinated polyethylene material at 100-150 degrees C. for 1-5 minutes. The preparation method is simple, environmentally friendly, efficient and low-cost, uniform micropores improve the elasticity of the foam material and reduce the density of the foam material, which is 0.2-0.3 g/cm3, and the foam wall is thin.

### CROSS-REFERENCE TO RELATED APPLICATIONS

The present application is a continuation of International Application No. PCT/CN2022/079781, with an international filing date of Mar. 8, 2022, which is based upon and claims priority to Chinese Patent Application No. 202110884402.2, filed on Aug. 3, 2021, the entire contents of all of which are incorporated herein by reference.

### TECHNICAL FIELD

The invention relates to the field of foaming technology, in particular to CO8G101/00, more in particular to a method for preparing foam materials by supercritical foaming.

### BACKGROUND

Chlorinated polyethylene is widely used because of its excellent weather resistance and solvent resistance. In CN201610058673, the foam material obtained by mixing chlorinated polyethylene, filling agent, foaming agent, crosslinking agent, lubricant and stabilizing agent, moulding and vulcanizing has weather resistance, chemical resistance and mechanical properties, but does not solve the problem of foam density; meanwhile, the chemical foaming agent is used to be mixed with the raw materials, so that foaming is not controlled, and it is difficult to ensure the foam uniformity. Therefore, it is necessary to provide a foaming method to solve the problem of uncontrolled foam, ensure the foam uniformity and smoothness, and improve the foaming density to expand the application range of chlorinated polyethylene materials.

### SUMMARY

In view of some problems existing in the prior art, the invention provides a method for preparing foam materials by supercritical foaming in the first aspect, including the following steps:

(1) Add the chlorinated polyethylene material into the reactor, add water and foaming nucleating agent, and then close the reactor cover;

(2) Heat to 50-80 degrees C.;

(3) Inject supercritical carbon dioxide into the reactor, so that the chlorinated polyethylene material can achieve saturation adsorption of supercritical carbon dioxide;

(4) Remove and treat the chlorinated polyethylene material at 100-150 degrees C. for 1-5 minutes.

The content of water in the invention is not specially limited, as long as the chlorinated polyethylene material can be immersed. The specific content can be conventionally chosen by the technicians in the field.

In one preferred embodiment, the water accounts for 60-80% of the volume of the reactor, more preferably 72 wt %

The foaming nucleating agent in the invention is not specially limited, and can be conventionally chosen by the technicians in the field.

In one preferred embodiment, the foaming nucleating agent accounts for 0.05-0.1 wt % of water, preferably 0.08 wt %.

Unexpectedly, the applicant finds that the foaming nucleating agent takes effect rapidly when the foaming nucleating agent accounts for 0.05-0.1 wt % of water.

The foaming nucleating agents can be listed as follows: calcium carbonate, clay, fiber crystal, butane, pentane and so on.

In one preferred embodiment, the foaming nucleating agent is pentane.

Preferably, pentane includes cyclopentane and n-pentane.

Further preferably, the weight ratio of cyclopentane and n-pentane is (4-6):1, more preferably 5:1.

Unexpectedly, the applicant finds that when the chlorinated polyethylene material includes the specific graphene in the invention, addition of a specific proportion of cyclopentane and n-pentane in the reactor can effectively avoid the heterogeneous nucleation caused by the foaming process of the chlorinated polyethylene material, reduce the foam size and increase the foam density.

In one preferred embodiment, in Step (2), the material is heated to 70 degrees C.

Unexpectedly, the applicant finds that when the material is heated to 50-80 degrees C., especially 70 degrees C., the final foam sizes are close and the differentiation is small.

In one preferred embodiment, in Step (3), supercritical carbon dioxide is injected to make the pressure in the reactor 20-30 MPa, preferably 25-28 MPa, more preferably 26 MPa.

Unexpectedly, the applicant finds that when the pressure of the reactor is 20-30 MPa due to the injection of supercritical carbon dioxide, the time for the chlorinated polyethylene material in the invention to achieve saturation adsorption of supercritical carbon dioxide is relatively short, so that the production efficiency is improved.

Preferably, supercritical carbon dioxide is injected in a segmented manner.

Segmented manner in the invention refers to the intermittent injection of supercritical carbon dioxide.

In a preferred embodiment, in Step (3), supercritical carbon dioxide is firstly injected at the rate of 2-5 MPa/s to make the pressure in the reactor reach 8-10 MPa and keep it for 15-20 minutes; then the supercritical carbon dioxide is injected again at the rate of 0.5-1 MPa/s to make the pressure in the reactor reach 12-15 MPa and keep it for 10-15 minutes; finally, the supercritical carbon dioxide is injected at the rate of 2-5 MPa/s to make the pressure in the reactor reach 20-30 MPa and keep it for a period of time until the chlorinated polyethylene material achieves saturation adsorption of supercritical carbon dioxide.

In a more preferred embodiment, in Step (3), supercritical carbon dioxide is firstly injected at the rate of 3 MPa/s to make the pressure in the reactor reach 8 MPa and keep it for 18 minutes; then the supercritical carbon dioxide is injected again at the rate of 0.6 MPa/s to make the pressure in the reactor reach 13 MPa and keep it for 12 minutes; finally, the supercritical carbon dioxide is injected at the rate of 2 MPa/s to make the pressure in the reactor reach 26 MPa and keep it for a period of time until the chlorinated polyethylene material achieves saturation adsorption of supercritical carbon dioxide.

In the experiments, the applicant finds that when the supercritical carbon dioxide is injected to make the pressure in the reactor 2-30 MPa, the foam uniformity and density of the final foam material obtained by the method cannot meet the requirements while improving the saturation adsorption efficiency. In the study, the applicant unexpectedly finds that the foam uniformity and density of the foam material finally obtained can meet the requirements when the supercritical carbon dioxide is firstly injected in a segmented manner at the rate of 2-5 MPa/s to make the pressure in the reactor reach 8-10 MPa and keep it for 15-20 minutes; then the supercritical carbon dioxide is injected again at the rate of 0.5-1 MPa/s to make the pressure in the reactor reach 12-15 MPa and keep it for 10-15 minutes; finally, the supercritical carbon dioxide is injected at the rate of 2-5 MPa/s to make the pressure in the reactor reach 20-30 MPa. The applicant thinks that the possible reason is that the supercritical carbon dioxide can be fully diffused into the chlorinated polyethylene material under such specific conditions to avoid affecting the diffusion of supercritical carbon dioxide into the chlorinated polyethylene material due to the diffusion resistance caused by viscosity when the supercritical carbon dioxide is injected. Meanwhile, the phenomenon of forming bubble barriers on the surface of the chlorinated polyethylene material may be avoided when the supercritical fluid is injected.

In one preferred embodiment, in Step (4), the chlorinated polyethylene material is removed and treated at 140 degrees C. for 3 minutes.

Unexpectedly, the applicant finds that when treated at 100-150 degrees C. for 1-5 minutes, the foam material obtained at this time avoids foams in the foams or on the boundary.

The specific type of chlorinated polyethylene material in the invention is not specially limited, and can be conventionally chosen by the technicians in the field.

The chlorinated polyethylene material in the invention can be self-made or purchased.

In one preferred embodiment, the chlorinated polyethylene material contains graphene.

In one preferred embodiment, the preparation method of the chlorinated polyethylene material includes: mix 65 parts of chlorinated polyethylene, 10 parts of natural rubber, 3 parts of calcium-zinc stabilizer, 10 parts of graphene, 0.2 part of stearic acid and 10 parts of dioctyl phthalate by weight, extrude and granulate through a single screw extruder, and then extrude at 100-150 degrees C. to get a molding plate; irradiate and crosslink the molding plate with the crosslinking irradiation dose of to obtain the chlorinated polyethylene material.

In a preferred embodiment, the preparation method of the chlorinated polyethylene material includes: mix 65 parts of chlorinated polyethylene, 10 parts of natural rubber, 3 parts of calcium-zinc stabilizer, 10 parts of graphene, 0.2 part of stearic acid and 10 parts of dioctyl phthalate by weight, extrude and granulate through a single screw extruder, and then extrude at 120 degrees C. to get a molding plate; irradiate and crosslink the molding plate with the crosslinking irradiation dose of to obtain the chlorinated polyethylene material.

Chlorinated polyethylene in the invention is not specially limited, and can be conventionally chosen by the technicians in the field.

In one preferred embodiment, the chlorinated polyethylene is purchased from Sichuan Jinsen Plastic Co., Ltd., and the brand is JS.

The natural rubber is purchased from Taizhou Zhonghong Waste Rubber Comprehensive Utilization Co., Ltd., and the commodity name is natural reclaimed fine rubber.

The calcium-zinc stabilizer is purchased from Jinan Hui Jinchuan Trading Co., Ltd.

The graphene is purchased from Shandong Xiangzhao New Material Co., Ltd., the brand is Xiangzhao, and the model is 001.

The undisclosed part of the preparation method for chlorinated polyethylene material in the invention can be conventionally selected by technicians in the field.

The invention provides a foam material prepared by a method for preparing foam materials by supercritical foaming in the second aspect.

Compared with the prior art, the invention has the following beneficial effects:

(1) The preparation method is simple, environmentally friendly, efficient and low-cost, uniform micropores improve the elasticity of the foam material and reduce the density of the foam material, which is 0.2-0.3 g/cm³, and the foam wall is thin.

(2) The foaming nucleating agent takes effect rapidly when the foaming nucleating agent with specific content is used, particularly 0.05-0.1 wt %.

(3) When the foaming nucleating agent consists of a specific proportion of cyclopentane and n-pentane, and the chlorinated polyethylene material includes the specific graphene in the invention, the heterogeneous nucleation caused by the foaming process of the chlorinated polyethylene material can be effectively avoided, thereby reducing the foam size and increasing the foam density.

(4) When the material is heated to 50-80 degrees C. in Step (2), especially 70 degrees C., the final foam sizes are close and the differentiation is small.

(5) When the supercritical carbon dioxide is injected to make the pressure of the reactor 20-30 MPa, the time for the chlorinated polyethylene material in the invention to achieve saturated adsorption of supercritical carbon dioxide is short, thereby improving the production efficiency;

(6) The foam uniformity and density of the foam material can meet the requirements by injecting the supercritical carbon dioxide in a segmented manner in the invention;

(7) When treated at 100-150 degrees C. for 1-5 minutes, the foam material obtained at this time avoids foams in the foams or on the boundary.

### BRIEF DESCRIPTION OF THE DRAWINGS

FIG. 1 is the SEM image of foam material obtained in the example 1 of the invention.

FIG. 2 is the SEM image of foam material obtained in the example 5 of the invention.

### DETAILED DESCRIPTION OF THE EMBODIMENTS

The invention is described below by means of embodiments, but is not limited to the examples given below.

### EXAMPLE 1

The example 1 of the invention provides a method for preparing foam materials by supercritical foaming, including the following steps:

(1) Mix 65 parts of chlorinated polyethylene, 10 parts of natural rubber, 3 parts of calcium-zinc stabilizer, 10 parts of graphene, 0.2 part of stearic acid and 10 parts of dioctyl phthalate by weight, extrude and granulate through a single screw extruder, and then extrude at 100 degrees C. to get a molding plate; irradiate and crosslink the molding plate with the crosslinking irradiation dose of 10KGy to obtain the chlorinated polyethylene material;

(2) Add the chlorinated polyethylene material to the reactor, add water accounting for 60% of the volume of the reactor, and add the foaming nucleating agent to close the reactor cover, in which the foaming nucleating agent accounts for 0.05 wt % of water, with the weight ratio 4:1 of cyclopentane and n-pentane;

(3) Heat to 50 degrees C.;

(4) Inject the supercritical carbon dioxide at the rate of 2 MPa/s to make the pressure in the reactor reach 8 MPa and keep it for 15 minutes; then inject the supercritical carbon dioxide again at the rate of 0.5 MPa/s to make the pressure in the reactor reach 12 MPa and keep it for 10 minutes; finally, inject the supercritical carbon dioxide at the rate of 2 MPa/s to make the pressure in the reactor reach 20 MPa and keep it for a period of time until the chlorinated polyethylene material achieves saturation adsorption of supercritical carbon dioxide.

(5) Remove and treat the chlorinated polyethylene material at 100 degrees C. for 5 minutes.

The chlorinated polyethylene is purchased from Sichuan Jinsen Plastic Co., Ltd., and the brand is JS; the natural rubber is purchased from Taizhou Zhonghong Waste Rubber Comprehensive Utilization Co., Ltd., and the commodity name is natural reclaimed fine rubber; the calcium-zinc stabilizer is purchased from Jinan Hui Jinchuan Trading Co., Ltd.; the graphene is purchased from Shandong Xiangzhao New Material Co., Ltd., the brand is Xiangzhao, and the model is 001.

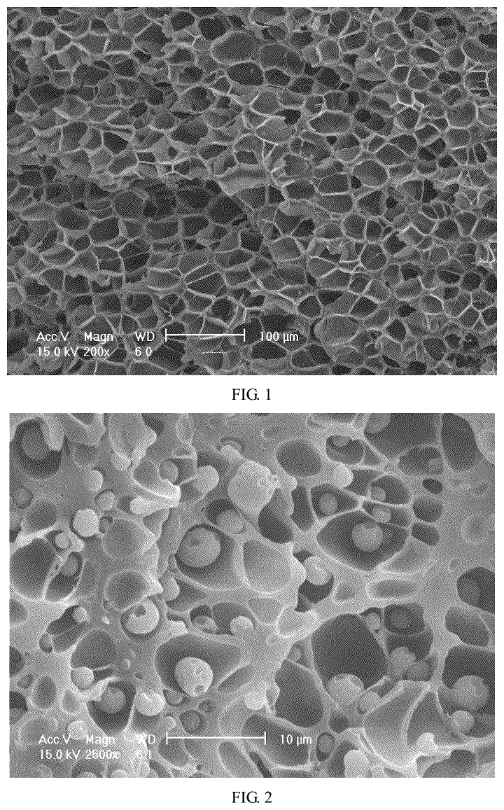

The SEM image of the foam material obtained in the embodiment is shown in FIG. 1, from which it can be seen that the foam material has orderly foams and large foam density.

### EXAMPLE 2

The example w of the invention provides a method for preparing foam materials by supercritical foaming, including the following steps:

(1) Mix 65 parts of chlorinated polyethylene, 10 parts of natural rubber, 3 parts of calcium-zinc stabilizer, 10 parts of graphene, 0.2 part of stearic acid and 10 parts of dioctyl phthalate by weight, extrude and granulate through a single screw extruder, and then extrude at 150 degrees C. to get a molding plate; irradiate and crosslink the molding plate with the crosslinking irradiation dose of 50KGy to obtain the chlorinated polyethylene material;

(2) Add the chlorinated polyethylene material to the reactor, add water accounting for 80% of the volume of the reactor, and add the foaming nucleating agent to close the reactor cover, in which the foaming nucleating agent accounts for 0.1 wt % of water, with the weight ratio 6:1 of cyclopentane and n-pentane;

(3) Heat to 80 degrees C.;

(4) Inject the supercritical carbon dioxide at the rate of 5 MPa/s to make the pressure in the reactor reach 10 MPa and keep it for 20 minutes; then inject the supercritical carbon dioxide again at the rate of 1 MPa/s to make the pressure in the reactor reach 15 MPa and keep it for 15 minutes; finally, inject the supercritical carbon dioxide at the rate of 5 MPa/s to make the pressure in the reactor reach 30 MPa and keep it for a period of time until the chlorinated polyethylene material achieves saturation adsorption of supercritical carbon dioxide.

(5) Remove and treat the chlorinated polyethylene material at 150 degrees C. for 1 minute.

The chlorinated polyethylene is purchased from Sichuan Jinsen Plastic Co., Ltd., and the brand is JS; the natural rubber is purchased from Taizhou Zhonghong Waste Rubber Comprehensive Utilization Co., Ltd., and the commodity name is natural reclaimed fine rubber; the calcium-zinc stabilizer is purchased from Jinan Hui Jinchuan Trading Co., Ltd.; the graphene is purchased from Shandong Xiangzhao New Material Co., Ltd., the brand is Xiangzhao, and the model is 001.

### EXAMPLE 3

The example 3 of the invention provides a method for preparing foam materials by supercritical foaming, including the following steps:

(1) Mix 65 parts of chlorinated polyethylene, 10 parts of natural rubber, 3 parts of calcium-zinc stabilizer, 10 parts of graphene, 0.2 part of stearic acid and 10 parts of dioctyl phthalate by weight, extrude and granulate through a single screw extruder, and then extrude at 120 degrees C. to get a molding plate; irradiate and crosslink the molding plate with the crosslinking irradiation dose of 35KGy to obtain the chlorinated polyethylene material;

(2) Add the chlorinated polyethylene material to the reactor, add water accounting for 72% of the volume of the reactor, and add the foaming nucleating agent to close the reactor cover, in which the foaming nucleating agent accounts for 0.08 wt % of water, with the weight ratio 5:1 of cyclopentane and n-pentane;

(3) Heat to 70 degrees C.;

(4) Inject the supercritical carbon dioxide at the rate of 3 MPa/s to make the pressure in the reactor reach 8 MPa and keep it for 18 minutes; then inject the supercritical carbon dioxide again at the rate of 0.6 MPa/s to make the pressure in the reactor reach 13 MPa and keep it for 12 minutes; finally, inject the supercritical carbon dioxide at the rate of 2 MPa/s to make the pressure in the reactor reach 26 MPa and keep it for a period of time until the chlorinated polyethylene material achieves saturation adsorption of supercritical carbon dioxide.

(5) Remove and treat the chlorinated polyethylene material at 140 degrees C. for 3 minutes.

The chlorinated polyethylene is purchased from Sichuan Jinsen Plastic Co., Ltd., and the brand is JS; the natural rubber is purchased from Taizhou Zhonghong Waste Rubber Comprehensive Utilization Co., Ltd., and the commodity name is natural reclaimed fine rubber; the calcium-zinc stabilizer is purchased from Jinan Hui Jinchuan Trading Co., Ltd.; the graphene is purchased from Shandong Xiangzhao New Material Co., Ltd., the brand is Xiangzhao, and the model is 001.

### EXAMPLE 4

The example 4 of the invention provides a method for preparing foam materials by supercritical foaming, including the following steps:

(1) Mix 65 parts of chlorinated polyethylene, 10 parts of natural rubber, 3 parts of calcium-zinc stabilizer, 10 parts of graphene, 0.2 part of stearic acid and 10 parts of dioctyl phthalate by weight, extrude and granulate through a single screw extruder, and then extrude at 120 degrees C. to get a molding plate; irradiate and crosslink the molding plate with the crosslinking irradiation dose of 35KGy to obtain the chlorinated polyethylene material;

(2) Add the chlorinated polyethylene material to the reactor, add water accounting for 72% of the volume of the reactor, and add the foaming nucleating agent to close the reactor cover, in which the foaming nucleating agent accounts for 0.08 wt % of water, with the weight ratio 5:1 of cyclopentane and n-pentane;

(3) Heat to 70 degrees C.;

(4) Inject the supercritical carbon dioxide at the rate of 3 MPa/s to make the pressure in the reactor reach 26 MPa and keep it for a period of time until the chlorinated polyethylene material achieves saturation adsorption of supercritical carbon dioxide.

(5) Remove and treat the chlorinated polyethylene material at 140 degrees C. for 3 minutes.

The chlorinated polyethylene is purchased from Sichuan Jinsen Plastic Co., Ltd., and the brand is JS; the natural rubber is purchased from Taizhou Zhonghong Waste Rubber Comprehensive Utilization Co., Ltd., and the commodity name is natural reclaimed fine rubber; the calcium-zinc stabilizer is purchased from Jinan Hui Jinchuan Trading Co., Ltd.; the graphene is purchased from Shandong Xiangzhao New Material Co., Ltd., the brand is Xiangzhao, and the model is 001.

### EXAMPLE 5

The example 5 of the invention provides a method for preparing foam materials by supercritical foaming, including the following steps:

(1) Mix 65 parts of chlorinated polyethylene, 10 parts of natural rubber, 3 parts of calcium-zinc stabilizer, 10 parts of graphene, 0.2 part of stearic acid and 10 parts of dioctyl phthalate by weight, extrude and granulate through a single screw extruder, and then extrude at 120 degrees C. to get a molding plate; irradiate and crosslink the molding plate with the crosslinking irradiation dose of 35KGy to obtain the chlorinated polyethylene material;

(2) Add the chlorinated polyethylene material to the reactor, add water accounting for 72% of the volume of the reactor, and add the foaming nucleating agent to close the reactor cover, in which the foaming nucleating agent accounts for 0.08 wt % of water, with the weight ratio 5:1 of cyclopentane and n-pentane;

(3) Heat to 70 degrees C.;

(4) Firstly inject the supercritical carbon dioxide at the rate of 3 MPa/s to make the pressure in the reactor reach 8 MPa and keep it for 18 minutes; then inject the supercritical carbon dioxide again at the rate of 0.6 MPa/s to make the pressure in the reactor reach 13 MPa and keep it for 12 minutes; finally, inject the supercritical carbon dioxide at the rate of 2 MPa/s to make the pressure in the reactor reach 26 MPa and keep it for a period of time until the chlorinated polyethylene material achieves saturation adsorption of supercritical carbon dioxide.

(5) Remove and treat the chlorinated polyethylene material at 160 degrees C. for 3 minutes.

The chlorinated polyethylene is purchased from Sichuan Jinsen Plastic Co., Ltd., and the brand is JS; the natural rubber is purchased from Taizhou Zhonghong Waste Rubber Comprehensive Utilization Co., Ltd., and the commodity name is natural reclaimed fine rubber; the calcium-zinc stabilizer is purchased from Jinan Hui Jinchuan Trading Co., Ltd.; the graphene is purchased from Shandong Xiangzhao New Material Co., Ltd., the brand is Xiangzhao, and the model is 001.

The SEM image of the foam material obtained in the embodiment is shown in FIG. 2, from which it can be seen that there are foams growing in the foams of the foam material.

### EXAMPLE 6

The example 6 of the invention provides a method for preparing foam materials by supercritical foaming, including the following steps:

(1) Mix 65 parts of chlorinated polyethylene, 10 parts of natural rubber, 3 parts of calcium-zinc stabilizer, 10 parts of graphene, 0.2 part of stearic acid and 10 parts of dioctyl phthalate by weight, extrude and granulate through a single screw extruder, and then extrude at 120 degrees C. to get a molding plate; irradiate and crosslink the molding plate with the crosslinking irradiation dose of 35KGy to obtain the chlorinated polyethylene material;

(2) Add the chlorinated polyethylene material to the reactor, add water accounting for 72% of the volume of the reactor, and add the foaming nucleating agent to close the reactor cover, in which the foaming nucleating agent accounts for 0.08 wt % of water, with the weight ratio 2:1 of cyclopentane and n-pentane;

(3) Heat to 70 degrees C.;

(4) Firstly inject the supercritical carbon dioxide at the rate of 3 MPa/s to make the pressure in the reactor reach 8 MPa and keep it for 18 minutes; then inject the supercritical carbon dioxide again at the rate of 0.6 MPa/s to make the pressure in the reactor reach 13 MPa and keep it for 12 minutes; finally, inject the supercritical carbon dioxide at the rate of 2 MPa/s to make the pressure in the reactor reach 26 MPa and keep it for a period of time until the chlorinated polyethylene material achieves saturation adsorption of supercritical carbon dioxide.

(5) Remove and treat the chlorinated polyethylene material at 140 degrees C. for 3 minutes.

The chlorinated polyethylene is purchased from Sichuan Jinsen Plastic Co., Ltd., and the brand is JS; the natural rubber is purchased from Taizhou Zhonghong Waste Rubber Comprehensive Utilization Co., Ltd., and the commodity name is natural reclaimed fine rubber; the calcium-zinc stabilizer is purchased from Jinan Hui Jinchuan Trading Co., Ltd.; the graphene is purchased from Shandong Xiangzhao New Material Co., Ltd., the brand is Xiangzhao, and the model is 001.

Performance Assessment

Foam morphology: The morphologies of the foams for the foam materials obtained in the examples 1-6 were respectively observed with an electron microscope to record whether the foams are regular and whether there are foams overlapped. Foam overlap refers to the presence of foams in the foams.

Foam density: The foam density of the foam materials obtained in the examples 1-6 were calculated respectively. Foam density refers to the number of foams per unit volume, in/cm 3. If the foam density is more than 9×10⁷/cm³, the material will be qualified; if the foam density is less than 9×10⁷/cm³, the material will be unqualified.

TABLE 1

| | | Foam |
|---|---|---|
| | Foam morphology | density |
| Example 1 | The foams are regular | Qualified |
| | without overlap | |
| Example 2 | The foams are regular | Qualified |
| | without overlap | |
| Example 3 | The foams are regular | Qualified |
| | without overlap | |
| Example 4 | The foams are regular | Unqualified |
| | without overlap | |
| Example 5 | The foams are irregular | Qualified |
| | and overlapped | |
| Example 6 | The foams are irregular | Unqualified |
| | and overlapped | |

What is claimed is:

1. A method for preparing foam materials by supercritical foaming, wherein the method includes the following steps:
(1) add the chlorinated polyethylene material into the reactor, add water and foaming nucleating agent, and then close the reactor cover;
(2) heat to 50-80° C.;
(3) inject supercritical carbon dioxide into the reactor, so that the chlorinated polyethylene material can achieve saturation adsorption of supercritical carbon dioxide;
(4) remove and treat the chlorinated polyethylene material at 100-150° C. for 1-5 minutes.

2. The method of claim 1, wherein in Step (3), supercritical carbon dioxide is injected to make the pressure in the reactor 20-30 MPa.

3. The method of claim 2, wherein in Step (3), supercritical carbon dioxide is injected in a segmented way.

4. The method of claim 3, wherein in Step (3), supercritical carbon dioxide is firstly injected at the rate of 2-5 MPa/s to make the pressure in the reactor reach 8-10 MPa and keep it for 15-20 minutes; then the supercritical carbon dioxide is injected again at the rate of 0.5-1 MPa/s to make the pressure in the reactor reach 12-15 MPa and keep it for 10-15 minutes; finally, the supercritical carbon dioxide is injected at the rate of 2-5 MPa/s to make the pressure in the reactor reach 20-30 MPa and keep it for a period of time until the chlorinated polyethylene material achieves saturation adsorption of supercritical carbon dioxide.

5. The method of claim 1, wherein in Step (4), the chlorinated polyethylene material is removed and treated at 140° C. for 3 minutes.

6. The method of claim 5, wherein water accounts for 60-80% of the volume of the reactor.

7. The method of claim 6, wherein the foaming nucleating agent accounts for 0.05-0.1 wt % of water.

8. The method of claim 6, wherein the foaming nucleating agent is selected from one or more of calcium carbonate, clay, fibrous crystal, butane and pentane.

9. The method of claim 8, wherein the chlorinated polyethylene material contains graphene.

10. A foam material prepared by the method of claim 1.
